(19) United States
(12) Patent Application Publication
(10) Pub. No.: US 2002/0144452 A1
(43) Pub. Date: Oct. 10, 2002

(54) More efficient and environmentally-desirable means of detecting insects entering lure-baited traps or attractive areas

(76) Inventor: Morton Beroza, Silver Spring, MD (US)

Correspondence Address: MORTON BEROZA, 821 MALTA LANE, SILVER SPRING, MD, 20901, US

(21) Appl. No.: 10/097,629

(22) Filed: Mar. 15, 2002

Related U.S. Application Data
(60) Provisional application No. 60/281,725, filed on Apr. 6, 2001.

(51) Int. Cl. A01M 1/20

(52) U.S. Cl. 43/107

(57) ABSTRACT

Detection and monitoring of insects of a given species can be facilitated by placing inside each lure-baited trap a microchip assembly that can sense the presence of that species (usually by the sound it makes); and then send electronic signals by satellite, internet, or antennae to a central monitoring station equipped with software that will identify locations of the traps (usually by trap number) as well as map locations of positive trap responses. Variations in the foregoing are: selection of species sound range may be made by microchip or by software at central monitoring station, use of multi-lure traps, periodic transfer of trap responses, method of determining whether the system is working properly, and use of microchip assembly units without traps to monitor sound-emitting life forms at sites attractive to the targeted species.

This invention relates to a new and more efficient means of detecting and monitoring the presence of insect or other species that respond to lure-baited traps [e.g., the Mediterranean fruit fly (or medfly), melon fly, gypsy moth, codling moth] or attractive sites.

Currently, traps containing lures, pheromones (sex attractants), etc., are used to detect insect pests. The traps are spread over wide geographical areas to capture and thereby monitor the presence of the targeted insect species. The information derived is used to determine where and when control measures—such as insecticide applications, sterile-insect release, pheromone release (confusion technique)★—are to be applied. The operation makes for a very efficient means of controlling or eradicating the targeted species from areas (especially large ones), and therefore is highly desirable from an agricultural and ecological standpoint. If pesticide is to be used, the procedure allows it to be applied only where needed and only as long as needed to effect control or eradication of the targeted species. Thus, the environment becomes less contaminated, and money is saved because less insecticide is used. Even more important, with rapid detection of an insect or similar pest, incipient infestations can be treated with insecticide or other control measures quickly, and thereby avoid their spread. ★ Beroza, M. Insect Attractants are Taking Hold, Agr. Chem. 15, 37 (1960)

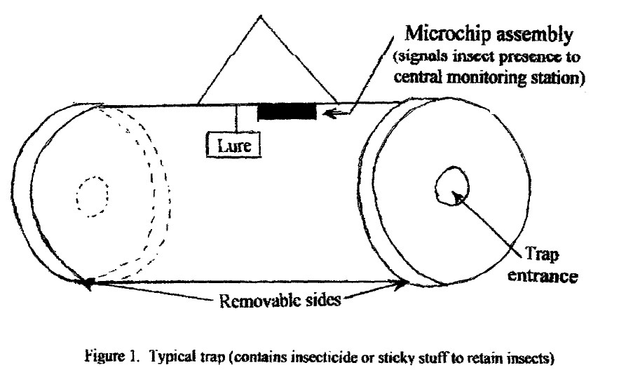

For example, to prevent the medfly from entering California, a great amount of time and money is currently being spent by the U.S. Department of Agriculture (USDA) to monitor this insect pest with lure-baited traps. Workers have to travel to and directly examine biweekly each of the 150,000 lure-baited traps that are dispersed over large areas, each usually at distances of a mile or more apart. FIG. 1 shows a typical trap.

To monitor the whereabouts of the targeted insect species, my idea is to place within each lure-baited trap a silicone microchip, or related device, that will signal the presence of one (or more) of the targeted species to a computer at a remote central location. The stimulus to which the microchip will respond is to be determined for each species. The stimulus can be a distinctive sound or sounds in a particular wavelength range, or an odor or chemical emitted by the the insect(s) that enters the trap. Even the flapping of the wings of a responding insect species, if unique, may be an adequate signal since the lure will tend to select the targeted insect species that enters the trap as well as excite it, and will likely cause it to flap vigorously.

That insects make highly specific sounds that are characteristic of their species has been known for some time. Termites are located by sounds they make. Thus, in their March 2001 issue of “Agriculture”, the U.S. Department of Agriculture published “Listening to Larvae”, which reported on the use of insect sounds to find harmful insects in the soil, thus eliminating the need to dig up large areas to determine where control measures are needed. In fact, Iowa State University has compiled a library of the unique sounds made by different insect species. Many sounds are digitized, which can facilitate electronic transmission and/or reception via a microchip. Among the many species for which such sounds have been recorded, are the medfly or Mediterranean fruit fly (Ceratitus capitata), the Caribbean fruit fly (Anastrepha suspensa), salt marsh mosquito (Aedes taeniorynchus).

Because computers, at a remote location, that are monitoring the chips in the traps will report positive trap captures as soon as they occur—and certainly far quicker than by the current periodic manual detection procedure—incipient infestations can be halted before they can spread. The procedure should also be useable to monitor insect populations over smaller areas (e.g., planted acreages), especially to eliminate incipient infestations before they can spread.

The potential use of the silicone-chip-baited traps that signal the targeted insect's presence to a remote central location can be significant. For example, 400,000 gypsy moth traps are dispersed each year over large areas of the eastern U.S. As noted, the medfly is kept out of California by about 150,000 lure-baited traps that are manually inspected biweekly; and more traps are deployed in Florida, Texas, and Mexico. With the medfly present in Europe, Africa, Australia, Pacific areas, and Central and South America, the traps are also used in many other parts of the world. The aforementioned insect species are only examples of the use of lure-baited traps. Many other insect species are now being monitored by pheromone- or lure-baited traps to effect their control or eradication. The procedure being advanced should be applicable to these species as well. Further, with today's computers, monitoring large numbers of such traps should be routine with the appropriate software, and thus avoid the very costly need to check each trap manually at rather frequent intervals.

Transmitting the desired information from the traps can probably be carried out best—and most inexpensively—by the internet or local antennae, or via a telephone company, such as AT&T, MCI, Sprint, or Verizon. Essentially, a battery- or solar-powered microchip or transmitter (modified phone device)—designed to respond solely to the sounds emitted by the targeted species—would send its positive signal(s) (preferably as digitized sound) to a distant central station that is set up to monitor the trap's responses. Location of the trap can be designated by trap number (which number can precede or follow each transmitted message), or by other means (latitude-longitude). The overall process may be viewed as a telephone call (or calls) to the monitoring station from the trap(s) as the targeted species is (or are) captured.

As a possibly superior option, trap sounds may be collected and stored in the trap, and then transmitted periodically (e.g., several times a day)) to the central computer.

With phone companies, their transmission services are already available to forward the signal(s) (via satellite) to the monitoring station, which need only have its own phone number to receive the desired signals. The signals can be received by a computer that will compile the data for each species and designate or map the location of the positive trap responses. If necessary or more convenient, antennae at 10- to 15-mile intervals can be used to relay trap responses to the central computer.

One of the high-tech companies (Microsystems, Cisco, Del, Intel, etc.) that manufacture microchips may help in the design and manufacture of the microchips.

In the simplest set-up being proposed, the microchip will transmit sounds from the trap to the central computer. The software in the computer will then be programmed to accept only the sound(s) of the targeted species, usually by restricting sound reception to the appropriate frequency range. Because a very large number of microchips would be needed, the microchips can be mass-produced, which would hold the cost/chip low. Properly protected (inside traps), the chips should last for a number of years, which will also hold down costs. Only inexpensive batteries, which can be large in size, will have to be replaced periodically, presumably about every 3 or 4 months.

The trap design used in insect trapping will vary according to the species and trapping means (e.g., insecticide, sticky stuff). Also, it may be desirable to have the trap sound-insulated (covered by a sound-insulating material); and it may even be possible to design the microchips to exclude outside sounds. Sounds made within the trap by entering insects will tend to be purer when sounds outside the trap are minimized.

Other means of saving time and money may involve placement of lures for two insect species in one trap; i.e., if it is determined that such an arrangement will attract and capture both species without interfering significantly with the trapping ability of either species. A microchip for each species could be placed in the trap, or a single microchip that responds to both species could be used. The computer software can then be set up to monitor captures of each species separately. Although unlikely, a trap attracting more than two species should not be ruled out because many of our currently used traps are being deployed solely to prevent invasion of a foreign insect species in areas essentially free of that species.

In essence, the method will facilitate detection of insects of a given species over large areas by placing inside each of the lure-baited traps a microchip that will 1. sense the presence of the targeted species by its sound, 2. send the sound (preferably digitized) to a computer at the central monitoring station to indicate that an insect of the targeted species has entered the trap, 3. designate the trap that the insect has entered, and 4. ultimately map the trap locations responding positively.

Other possibilities and considerations: Traps of this patent could be used to track beneficial insects as well as other life species, e.g., arachnida. In some cases, it may be desirable to have the microchip itself able to receive and transmit only the sounds emitted by the targeted species. Another possibility would be to provide a central monitoring station for each area code of a phone company, if thereby, sound transmission is made purer and/or more reliable.

To detect defects, it is planned to send a signal to all traps periodically (e.g., the sound of the targeted insect itself) to determine whether their microchips are working properly; traps not responding can then have their equipment replaced or repaired. To avoid confusion, these signals can be sent preferably when the insect does not respond to the lure, e.g., at midnight.

Lures lasting longer than those in current use are likely to be needed in the foregoing applications. There should be no problem in extending lure duration.

As one other possibility, the foregoing system may be used to detect specific sounds of any life form without the use of traps. Thus, the microchip assemblies can be located at or near plants, trees, or certain given locations that attract insects or animals that emit specific sounds; sounds of the targeted species received at the monitoring station disclose the location(s) of the targeted species.

What is claimed is:

1. Method of facilitating detection of insects (or other life forms) of a given species in agricultural or other areas by placing inside each lure-baited trap a microchip that will detect the presence of an insect of that species (usually by the sound it makes), and then send an electronic signal (digitized sound preferred) via satellite, internet, or antennae to a central monitoring station equipped with software that will identify positive trap responses and their locations as well as map locations of the positive responses.

2. Method of claim 1 in which lures for more than one insect species are put into each trap if it is shown that captures of the individual species are not decreased significantly when compared with their captures in traps baited with a single lure; with multi-lure traps, computers have to be set up with software that will monitor the captures of each species separately, generally by difference in the sound frequency response range of each species.

3. Method of claim 1 in which the microchip(s) in the trap(s) can be adjusted so that the sound(s) received and the signal(s) sent to the central monitoring station can be varied for each targeted species.

4. Method of claim 1 in which trap signals are collected in the trap and then transmitted at given time intervals (e.g., several times a day) to the central computer.

5. Method of claim 1 in which the computer receiving signals of trap captures can determine periodically whether the microchips are working properly by sending a positive signal of the targeted species to all the traps to determine whether the microchips are responding. Microchips not responding properly can then be replaced or repaired.

6. Method of claim 1 in which the microchip assemblies are not placed in traps but at attractive locations, e.g., at or near certain plants or trees, or water sources that attract insects or animals that emit specific sounds; sounds of the targeted species received at the monitoring station indicate the location(s) of the targeted species.
